(19) United States
(12) Patent Application Publication
(10) Pub. No.: US 2010/0222464 A1
(43) Pub. Date: Sep. 2, 2010

(54) EMULSION OF A POLYMER MODIFIED ASPHALT

(75) Inventors: James J. Barnat, Tulsa, OK (US); Vincent Vopat, Tulsa, OK (US)

Correspondence Address: HEAD, JOHNSON & KACHIGIAN, 228 W 17TH PLACE, TULSA, OK, 74119, US

(73) Assignee: SEMMATERIALS, L.P., Tulsa, OK (US)

(21) Appl. No.: 12/395,210

(22) Filed: Feb. 27, 2009

(51) Int. Cl. C08L 95/00

(52) U.S. Cl. 524/60

(57) ABSTRACT

A method for formulating an emulsified polymer modified asphalt, and the emulsion thus created. The method includes mixing at least one polymer and a first binder in a high shear device to produce a polymer-binder composite; mixing the polymer-binder composite with a second binder to form a polymer modified asphalt; and emulsifying the polymer modified asphalt by combining effective amounts of an emulsifying agent and of water with the polymer modified asphalt.

### FIELD OF THE INVENTION

The present invention relates to an emulsified polymer modified asphalt and more particularly, but not by way of limitation, to an emulsion of a polymer modified asphalt provided by diluting a polymer-binder composite described herein with an asphalt or bituminous material. The present invention also relates to a method of making the emulsified polymer modified asphalt.

### DESCRIPTION OF THE RELATED ART

Polymer composites that employ asphalt as a binder or extender can be used in numerous industries that require enhanced adhesive or cohesive properties, including roofing, road building, and flooring.

Asphaltic concrete, which typically includes asphalt and aggregate, must exhibit certain specific physical or mechanical properties to enable its use in various fields of application, particularly when used as a binder for road surfacing, as an asphalt emulsion, or for industrial applications. The term “asphalt” as used herein refers to petroleum based bitumen, but the teaching of this invention can also be applied to other types of bituminous materials. The use of asphalt or asphalt emulsion binders either in maintenance facings as a surface coat or as a very thin bituminous mix, or as a thicker structural layer of bituminous mix in asphaltic concrete, is enhanced if these binders possess the requisite properties such as desirable levels of elasticity and plasticity.

Conventional asphalts often do not retain sufficient elasticity and have a plasticity range that is too narrow for use in many applications, such as, for example, in road construction. The use of asphalt or asphalt emulsion binders is enhanced if these binders can be modified so that they possess the requisite levels of elasticity and plasticity. Such performance characteristics of road asphalts are greatly improved by incorporating polymers into them. The resulting polymer modified binders exhibit superior rheological behavior. Such polymers may be butyl, polybutadiene, polyisoprene or polyisobutene rubber, or other ethylene-butadiene polymers. Other polymers may include ethylene/vinyl acetate copolymer, polyacrylate, polychroloprene, polymorbornene, polyethylene, polypropylene, ethylene/propylene/diene (EPDM) terpolymer and a random or block copolymer, or styrene and a conjugated diene.

The modified asphalts that are thus produced are commonly referred to as polymer-bitumen binders or polymer-asphalt binders. These polymer modified asphalts, as well as asphalt emulsions made therefrom, typically are produced utilizing styrene/butadiene based polymers, and they typically have a raised softening point, increased viscoelasticity, enhanced force under strain recovery, and improved low temperature strain characteristics. If the polymer modified asphalts and asphalt emulsions are to be employed for road construction or repair, the addition of polymer to the bituminous binder material improves the rheological properties and results in pavement material that is stiffer and less susceptible to rutting. U.S. Pat. No. 5,314,935 issued to Chaverot et al. teaches families of crosslink agents, and U.S. Pat. No. 4,242,246 to Maldanado et al. teaches various polymers and asphalt modifiers. The teachings of these two patents are included herein by reference.

Polymer enhanced or modified asphalts are routinely used in the road construction, road maintenance, and roofing industries. For purposes of illustration only, the invention will be described primarily herein as polymer enhanced asphaltic concrete used in association with road building applications, but the invention is not so limited and can be employed in any number of other applications and with any type of bituminous binder, such as emulsification applications.

These polymer-bitumen composites can be used in a number of ways. First, they can be diluted with additional binder, which lowers the polymer concentration of the composite and allows the use to derive the desired physical properties from the resultant binder. Second, the composite can be used as-is and directly added to the final product, such as hot mix asphalt. Here the composite is added as a separate stream to the mixing process and is incorporated as the composite. Finally, the composite can be further processed to yield additional rheological properties or another physical form that may be more convenient for the desired process.

In order to achieve a given level of modified asphalt performance, various polymers are added to the asphalt or bituminous binder at some prescribed concentration. Current practice is to add the desired level of one or more polymers, sometimes along with a reactant, which promotes crosslinking of the polymer molecules, until the desired rheological properties are met. A typical reactant used is sulfur in a form that is suitable for crosslinking.

The cost of polymer adds significantly to the overall cost of the resulting asphalt-polymer composite mix. Thus, the use of polymer is a factor in the ability to meet desired physical, mechanical, and economic criteria Also, at increased levels of polymer concentration, the working viscosity of the asphalt mix becomes too great and requires excessive temperatures to handle. These excessive temperatures degrade the polymer and the Theological performance of the polymer-binder composite, as well as make emulsification more difficult.

Typically, bituminous polymer-binder composites are made in various ways, including through a low shear mixing method and through a medium shearing mixing method. The low shear method is the typical method employed in creating polymer-binder composites for use in many applications like the road building industry. The low shear method employs a low shear mixer such as the type manufactured by MixMor at 3131 Casitas Avenue, Los Angeles, Calif. 90039. In the low shear method, binder is heated until sufficiently fluid before polymer pellets are added to the mixer. Typically, the temperature is approximately 350° to 450° F if asphalt is employed as the binder. The mixer is operated at a shear rate of less than 5 s⁻¹, with a mixing pressure of approximately 0 to 1.0 psi. The polymer and binder are mixed until the polymer disperses or becomes soluble in the binder. The process time is usually greater than 3 hours to achieve full solubility of the polymer in the binder at a concentration of typically about 6 wt. % polymers. A polymer concentration of about 6 wt. % is typical because the polymer thickens the composite mixture and higher concentrations of polymer result in a mixture that is too thick to process in a low shear mixing process. For this reason, the upper limit of polymer concentration is approximately 20 wt. % polymer when mixed in a low shear mixer.

Where the low shear method of making polymer-binder composites is employed, the initial 6+ wt. % polymer composite is trucked, while in a hot state, to one or more secondary mixing facilities where the composite material is then further diluted with bitumen for road building. The polymer concentration in the final composite material produced in the secondary mixing facilities is approximately 2 to 5 wt. %. A centralized distribution system is employed because of the high cost of mixing equipment involved in the initial mixing of the polymer and the binder to produce the 6+ wt. % polymer composite. Less expensive low shear mixers are used at the destination facilities to mix the composite with additional binder. By having an expensive central processing facility that can then supply composite to several lesser expensive destination facilities, the total cost of facilities needed to produce the composite material needed for such applications as road building is reduced.

The medium shear method employs mills such as the type manufactured under the Supraton® trademark by the German company Buckau-Wolf, the MP10S mill produced by Dalworth Machine Products, Inc. located at 5136 Saunders Road, Fort Worth, Tex. 76119, or colloid mill such as those manufactured under the Charlotte® trademark and available from Chemicolloid Laboratories Inc., 55 Herricks Road, Garden City Park, N.Y. 11040-5260.

In the medium shear method, the liquid bitumen cement and polymer pellets are heated to a temperature of between approximately 350° to 450° F. in a pre-wet tank before being pumped through a shearing zone of the mill and into a tank, from which a recirculation line allows the mixture to be repeatedly passed through the shearing zone until the desired solubility is achieved. Alternatively, in some equipment, the solid polymer is fed directly to the mill. A system utilizing the medium shear method usually circulates the polymer-bitumen composite continuously through the mill until it is dispersed. The mill is typically operated at a shear rate greater than 25,000 s⁻¹, with a mixing pressure of approximately 35 to 50 psi. Under such conditions, the mix time is approximately 1 to 4 hours to achieve full solubility of the polymer in the bitumen binder at a concentration of typically 12 to 15 wt. % polymers. Approximately 26 wt. % polymer concentration is the upper limit of polymer concentration possible in the composite using the medium shear method. The medium shear method is able to handle longer chain polymers up to a maximum polymer molecular weight of approximately 200,000 Dalton (Da). As with the low shear method, the composite produced with the medium shear method may be transported to secondary facilities to be further diluted with binder.

The low and medium shear methods of making polymer-binder composites have several drawbacks. The primary mixing operation takes anywhere from approximately 3 to 6 hours to complete in the low shear method. The medium shear method improves on this time by reducing the time to approximately 1 to 4 hours. However, it would be desirable to further reduce the mix time so that larger quantities of product could be produced faster at a given facility.

Next, the concentration of polymer in the product produced by the primary mixing operation using the low shear method is typically about 6 wt. %, with a maximum of approximately 20 wt. %. Employing the medium shear method, the concentration is typically about 12 to 15 wt. %, with a maximum of approximately 26 wt. %. It would be desirable to produce a composite with a much higher polymer concentration, possibly in the 90+ wt. % range, since the higher concentration of polymer would reduce the amount of bitumen that would have to be trucked from the primary mixing facility to the secondary mixing facilities. If the concentration of polymer could be significantly increased in the polymer-binder composite, the cost savings in transportation could be significant.

Further, the low shear method of mixing works well with polymers of molecular weights below about 100,000 Da and the medium shear method works with polymers of molecular weights below about 200,000 Da, but neither method works with polymers with higher molecular weights, i.e. polymers with molecular weights greater than 200,000 Da. The lower molecular weight polymers are molecules with shorter chain lengths than that of the higher molecular weight polymers. It would be desirable to employ longer chain polymers with molecular weights greater than 200,000 Da as these molecules would be able to achieve the desired rheology for the composite at lower polymer concentrations and therefore at lower polymer cost. However, the longer chain polymers having molecular weights greater than 200,000 Da are not easily dispersed and are prone to separation. This separation is due to a lack of homogeneity, and the resultant instability is measured by an industry standard Ring and Ball Separation Test. The higher molecular weight molecules have longer chains that unfold and build an efficient intra-penetrating network (IPN). The IPN builds superior theological properties allowing the composite to better resist flowing and deformation. An additional benefit to employing higher molecular weight molecules is a reduction in the cost of cross-linking agents, which are needed in larger quantities when shorter chain length polymers are employed.

Additionally, both the low shear and medium shear methods of mixing produce a mixture that must be maintained in a heated state during transport to the secondary mixing facilities. It would be desirable to produce a composite product that is capable of being stored in a warehouse at ambient temperature after production and before being transported to the secondary mixing facilities.

One result of the high viscosities experienced at increased polymer concentrations is that emulsification of the asphalt is more difficult. As is known in the art and used herein, emulsification of asphalt refers to forming an emulsion of asphalt and water. Asphalt emulsions are desirable in many applications because an emulsion may be applied at lower temperatures than hot-mix asphalts because the water acts as a carrier for the asphalt particles. For example, hot-mix asphalts, which are mixes of asphalt, aggregate, and a single polymer, are commonly applied at a temperature of 140° C. to 232° C. to achieve the requisite plasticity for application. In comparison, an asphalt emulsion typically may be applied at 54° C. to 77° C. to achieve the same working characteristics. Once applied, the water evaporates, leaving the asphalt. Also, emulsified asphalt products generally do not use or release the environmentally-harmful volatile organic compounds normally associated with asphalts diluted with light carrier solvents such as diesel fuel, naphtha, and the like.

Emulsification basically requires that the asphalt and any desired performance-enhancing additives be combined with an emulsifying agent in an emulsification mill along with about 20 to 80 percent by weight of water, or between 20 and 80% by weight binder. However, high polymer loadings in an asphalt produce high viscosities and high melting points, making emulsification of the polymer-asphalt composition difficult. Thus, emulsification of the prior art single polymer composition effectively is limited to lower polymer concentrations not producing excessively viscous (stiff) working asphalt-polymer fluids.

To this end, a need exists to produce an improved emulsified polymer modified asphalt wherein the polymer modified asphalt is provided by diluting, with asphalt or bituminous material, a polymer-binder composite containing a high percentage of polymers employing a high shear method. It is to such an improved emulsified polymer modified asphalt and method of producing such an improved emulsified polymer modified asphalt that the present invention is directed.

### SUMMARY OF THE INVENTION

In general, in a first aspect, the present invention relates to an emulsified polymer modified asphalt, comprising: a polymer-binder composite, comprising at least one polymer and a first binder, where the at least one polymer and the first binder are combined in a high shear device to form the polymer-binder composite; a second binder, where the second binder is mixed with the polymer-binder composite to form a polymer modified asphalt; and effective amounts of an emulsifying agent and of water to allow emulsification of the polymer modified asphalt. The emulsifying agent may be cationic, anionic, nonionic, amphoteric, or zwitterionic.

The emulsified polymer modified asphalt may further comprise at least one emulsion additive, which may be selected from the group consisting of latex rubber, sulfur containing compounds, thickeners, or other rheology modifiers, tackifiers, flow improvers, pH adjusting chemicals, stabilizers and the like. The polymer-binder composite may further comprise at least one additive. The at least one polymer may have a molecular weight greater than about 60,000 Da, greater than about 100,000 Da, greater than about 150,000 Da, or greater than about 200,000 Da.

The polymer-binder composite mixture may be readily soluble when combined with the second binder. The at least one polymer and the first binder may be subjected to mixing with a resident time in the high shear device of greater than about 0.5 seconds. Also, they may be subjected to mixing with a scalar shear quantity of greater than about 250, greater than about 1000, or greater than about 1500. Greater than 0.05 kW/kg, greater than 0.1 kW/kg, or greater than 0.2 kW/kg of energy may be utilized to combine the at least one polymer and the first binder. The at least one polymer and the first binder may subjected to mixing where the high shear device produces a pressure of greater than 100 psi and maintains laminar flow. Also, the at least one polymer and the first binder may be subjected to mixing where the high shear device maintains RPMs of less than 1,500 and laminar flow.

In a second aspect, the present invention relates to a method for formulating an emulsified polymer modified asphalt, comprising: mixing at least one polymer and a first binder in a high shear device to produce a polymer-binder composite; mixing the polymer-binder composite with a second binder to form a polymer modified asphalt; and emulsifying the polymer modified asphalt by combining effective amounts of an emulsifying agent and of water with the polymer modified asphalt. The high shear device may be a high shear extruder.

Mixing the at least one polymer and the first binder in the high shear device to produce the polymer-binder composite may further comprise mixing at least one additive into the high shear device along with the at least one polymer and first binder to produce the polymer-binder composite. Mixing the at least one polymer and the first binder in the high shear device to produce the polymer-binder composite may be accomplished in less than one minute. The at least one polymer may have a molecular weight that is greater than 60,000 Da, greater than 100,000 Da, greater than 150,000 Da, or greater than 200,000 Da.

Mixing the at least one polymer and the first binder in the high shear device to produce the polymer-binder composite may further comprise subjecting the at least one polymer and the first binder to mixing with a resident time in the high shear device of greater than 0.5 seconds. It may also further comprise subjecting the at least one polymer and the first binder to mixing with a scalar shear quantity of greater than about 250, greater than about 1,000, or greater than about 1,500. Greater than 0.05 kW/kg, greater than 0.1 kW/kg, or greater than 0.2 kW/kg of energy may be utilized to mix the at least one polymer and the first binder in the high shear device to produce the polymer-binder composite. The emulsifying agent may be cationic, anionic, nonionic, amphoteric, or zwitterionic.

The method may further comprise the step of transporting the polymer-binder composite to a secondary location prior to mixing the polymer-binder composite with the second binder to form the polymer modified asphalt. The method may further comprise the step of storing the polymer-binder composite for a predetermined amount of time prior to transporting the polymer-binder composite to the secondary location. The step of emulsifying the polymer modified asphalt by combining effective amounts of an emulsifying agent and of water with the polymer modified asphalt may further comprise combining an effective amount of an additive with the emulsifying agent and the water. The additive may be selected from the group consisting of latex rubber, sulfur containing compounds, thickeners, or other rheology modifiers, tackifiers, flow improvers, pH adjusting chemicals, stabilizers and the like.

### DETAILED DESCRIPTION OF THE PREFERRED EMBODIMENT

The present invention relates to an emulsified polymer modified asphalt and a method of producing the same. The emulsified polymer modified asphalt is produced by combining at least one polymer with a binder in a high shear device to form a polymer-binder composite, mixing the polymer-binder composite with a second binder to form a polymer modified asphalt, and emulsifying the polymer modified asphalt. The benefits of this process are a short mix time, very high polymer concentrations, the ability to use long chain polymers, the ability to store the composite at ambient temperature, and easy emulsification of the polymer modified asphalt.

The present invention reduces the primary mixing operation to less than an hour, preferably less than 30 minutes, and most preferably less than 3 minutes. The present invention also produces a composite with polymer concentrations greater than 26%, preferably greater than 50%, more preferably greater-than 75%, and most preferably greater than 90 wt. %. Further, the present invention employs polymers that require less polymer and less cross-linking agents to achieve the desired composite rheology, thereby resulting in less expense to produce the desired product. Still further, the present invention produces a product that can be cooled and cut into pellets that are dry and remain stable at normal temperatures, allowing it to be stored and transported without heating. The present invention has the additional advantage of being soluble in less than 3 hours, preferably soluble in less than 2 hours, more preferably soluble in less than 1 hour, or most preferably soluble in less than 15 minutes with bitumen when mixed with liquid bitumen at the secondary mixing facilities, thereby reducing the mix time necessary to produce the final composite needed for such applications as road building, roofing, or other adhesive applications.

The present invention employs a high shear device, like an extruder or a roll mill, for combining the polymer and bituminous binder. If an extruder is employed as the high shear device, it can be either a single screw or double screw type. If the extruder is a double screw type, then it can be either a co-rotating or counter rotating type. Such extruders are manufactured by American Leistritz Extruder Corporation located at 169 Meister Avenue, Somerville, N.J. 08876 and by American Kuhne located at 31 Connecticut Avenue, Norwich, Conn. 06360.

These high shear devices operate at a shear rate of greater than 1000 s⁻¹ and at pressures greater than 100 psi, and can mix the polymer and binder together in less than an hour, preferably less than 10 minutes, and most preferably less than one minute. At least one polymer and at least one binder are fed into the high shear device to produce the composite. Optionally, at least one additive is also fed into the high shear device with the polymer and binder to produce the composite. Concentrations greater than 26%, preferably greater than 50%, more preferably greater than 75%, and most preferably greater than 90 wt. % polymer in the composite are achievable with this method. In fact, the present method is capable of producing polymer binder composite with a polymer concentration of less than 99.9 wt. %, with a bituminous material or binder concentration of less than 74 wt. %, preferably less than 50%, more preferably less than 25%, and most preferably less than 10%.

The polymer and the bituminous binder have a resident time in the high shear mixing device sufficient to provide a polymer-binder composite that is substantially homogeneous. The polymer is pre-dispersed in the binder. In one embodiment, the polymer and the bituminous binder have a resident time in the mixing device of greater than about 0.5 seconds. In another embodiment, the polymer and the bituminous binder have a resident time in the mixing device or greater than about 1.5 seconds. In a further embodiment, the polymer and the bituminous binder have a resident time in the mixing device of greater than about 5.0 seconds.

The polymer-composite is ideally processed in laminar flow. In fluid dynamics, there are three types of flow: laminar flow, turbulent flow, and transitional flow. In nonscientific terms, laminar flow is smooth, turbulent flow is rough, and transitional flow is a mixture of both smooth and rough flow.

The dimensionless Reynolds number is an important parameter in equations that describe whether flow conditions lead to laminar or turbulent flow and is important in analyzing any type of flow when there is substantial velocity gradient or shear. It indicates the relative significance of the viscous effect compared to the inertia effect. The Reynolds number is proportional to the inertial forces divided by the viscous forces.

Laminar flow, which is sometimes known as streamline flow, occurs when a fluid flows in parallel layers, with no disruption between layers. In laminar flow the Reynolds number is less than approximately 2300. Laminar flow is characterized by high momentum diffusion, low momentum convection, and pressure and velocity independence from time. Shear stress in laminar flow is independent of the density and depends almost entirely on the viscosity.

Turbulent flow produces flow vortices, eddies, and wakes, which make the flow unpredictable. Turbulent flow happens, in general, at high flow rates. In turbulent flow the Reynolds number is generally greater than approximately 4000.

Transitional flow is a mixture of laminar and turbulent flow, with turbulence in the center of the pipe and laminar flow near the edges. In transitional flow, the Reynolds number is generally between approximately 2300-4000. Each of these flows behaves in a different manner in terms of frictional energy loss while flowing and has a different equation that predicts such behavior.

Although higher shear rates are achievable, the scalar shear quantity (the product of shear rate and resident time within the shear zone), resident time, and energy per unit mass are important for the present invention. Shear rate is calculated as follows:

Sᵣ=V/g

where V is the tip speed and g is the gap.

Table 1 below shows the resulting values for these parameters when different high shear devices are employed for the present invention. A traditional rotor stator medium shear mill like Dalworth MP102S would typically have a diameter of the shearing implement of 10 inches, a gap of around 0.040 inch, a rotation of 3600 RPM, and a product flow rate of 350 GPM. This yields a maximum shear rate of <50,000 s⁻¹. The resident time of this process within the shear zone is <1 second. A scalar shear quantity representing the product of the shear rate and the resident time represents the time the product is in the highest shear zone. The scalar shear quantity is about 130 in this example. Finally, the specific energy is defined as the amount of energy utilized to produce the product and is approximately 0.005 kilowatt per kg.

Energy is required to disperse a polymer into a binder. High temperatures for a prolonged period of time is one way to add energy and another is mechanical shear. Temperatures at 175° C. and above thermally degrade many polymers that are suitable for the road paving industry. Reducing process times at high temperatures like >175° C. are desirable to preserve the integrity of the polymers. Mechanical shear allows the transference of high amounts of energy over short periods of time. Hence, higher amounts of specific energy are beneficial in preserving the integrity of the polymers as well as storing polymer-binder composites at low temperatures like room temperature. A high specific energy allows for a substantially dispersed polymer-binder composite in a short time period. A specific energy greater than 0.05 kW/kg is preferred, greater than 0.10 kW/kg is more preferred, and greater than 0.20 kW/kg is most preferred.

Alternatively, a twin screw extruder may be employed. A large commercial twin screw extruder has two shafts rotating. Ideally, the gap between the shearing implements and the wall and/or the matched element is required to be no greater than about 0.50 mm and the rotation is typically between 400 and 600 RPM. This yields a maximum shear rate of approximately 8,500 s⁻¹ or more. With deep flight elements, the resident time in the high hear device is about 1.23 seconds, producing a scalar shear quantity of approximately 10,000 and a specific energy of approximately 0.30 kilowatt per kg within the transitional or laminar flow regime and more preferred within the laminar flow regime.

TABLE 1

| | | | | Scalar Shear |
|---|---|---|---|---|
| | | Resident Time | Energy | Quantity (Shear |
| Device | Sr Max | (s) | (kW/kg) | Rate * Time) |
| Ideal High Shear | 8,419 | 1.23 | .29 | 10,347 |
| Device | | | | |
| Dalworth | 47,124 | 0.0036 | 0.0047 | 131 |

As described herein, the polymer and the bituminous binder can be subjected to a wide range of scalar shear quantities while being mixed. In one embodiment of the present invention, the polymer and the bituminous binder are subjected to a scalar shear quantity that is greater than about 1,000. In a further embodiment, the polymer and the bituminous binder are subjected to a scalar shear quantity that is greater than about 1,500.

In accordance with the present invention, a wide range of energy can be utilized while mixing the polymer and the bituminous binder. In one embodiment of the present invention, the energy utilized while mixing the polymer and the bituminous binder is greater than about 0.05 kW/kg. In another embodiment of the present invention, the energy utilized while mixing the polymer and the bituminous binder is greater than about 0.10 kW/kg. In a further embodiment of the present invention, the energy utilized while mixing the polymer and the bituminous binder is greater than about 0.20 kW/kg.

In one embodiment of the present invention, the composite can be extruded or rolled out of the extruder or roll mill in a long string. In another embodiment of the present invention, the composite can be pelletized using underwater pelletizing systems. Examples of pelletizing systems include, but are not limited to, underwater pelletizing systems provided by Gala Industries, Inc., and the like. It should be understood and appreciated that any suitable pelletizing system can be implemented to pelletize the composite of the present invention.

When composite is cooled, it can then be cut into pellets. These pellets are stable at normal temperatures and can be stored without heating and transported without heating to secondary mixing facilities. Storing the pellets at low temperatures preserve the integrity of the polymers within polymer-binder composite. These pellets have the additional benefit of mixing instantly, almost instantly, or within less than 3 hours when added to additional binder in the low shear mixers found at the secondary mixing facilities.

Polymers employed in the present invention may be, but are not limited to, elastomers, plastomers, elastomer/plastomer combination polymers, oligomers, monomers, and functionalized polymers, oligimers, and monomers. Polymers may include, but are not limited to, urethane, natural rubber, epoxy, styrene-butadiene (SB), styrene-ethylene/butylenes-styrene (SEBS), styrene-butadiene (SBR), polyetheretheketones (PEEK), polyethylene terephthalate (PET), low-density polyethylene (LDPE), polyethylene (PE), nylon, amorphous poly-alpha-olefins (APAO), ethyl methacrylate (EMA), and ethylene-vinyl acetate (EVA). The polymers used in the composite may have varying molecular weights, i.e. molecular weights greater than about 60,000 Da, preferably greater than about 100,000 Da, more preferably greater than about 150,000 Da, or most preferably greater than about 200,000 Da.

Binders employed in the present invention may be any type of bituminous material or hydrocarbon resin, including, but not limited to, petroleum based asphalt or coal based coal tar or pitch. Typical bituminous material that can be employed as a binder in the present invention would include, but are not limited to, asphalt cement (AC), pitch, tar, asphalt, vacuum tar bottoms (VTB), resid, performance grade (PG) asphalts, flux, or petroleum products.

Additives employed in the present invention may include, but are not limited to, cross linkers or vulcanizing agents, inhibitors, resins/rosins, compatibilizers, fibers and surfactants. Cross linkers may include, but are not limited to, sulfur, sulfur donating compounds, amines, oxides and epoxides.

Inhibitors may include, but are not limited to, phenols, anti-oxidation chemicals and free radical scavengers. Resins/rosins may include, but are not limited to, phenolic compounds, resin/rosin acids and salts, and tofa resins. Compatibilizers may include, but are not limited to, sufacants, process oils, resins, rosins and polyphosphoric acid (PPA). Fibers may include, but are not limited to, Kevlar® fibers, cellulose, polypropylene (PP), polyethylene (PE), and polyester. Surfactants may include, but are not limited to, process oils, resins, rosins, and polyphosphoric acid (PPA). As noted above, the polymer-binder composite may be mixed with a second binder to form a polymer modified asphalt. This mixing may occur at a secondary facility under low, medium, or high shear conditions. The polymer-binder composite is dispersed in a second binder in less than three hours, preferably in less than 2 hours, more preferably in less than 1 hour, and most preferably in less than 15 minutes. Additionally, the polymer modified asphalt may be emulsified for various applications.

Typically, a polymer modified asphalt, once produced, has a limited storage life and can only be maintained at low concentrations (e.g. 3 wt %). The polymer modified asphalt is usually produced at maximum polymer concentrations (e.g. 6 to 9%) to assist process efficiencies and to minimize costs. The maximum concentration is typically limited by the ability to maintain sufficient flow characteristics. Additionally, under-heated storage the polymers may thermally crosslink, thereby toughening the polymer network and hindering emulsification. The typical polymer modified asphalt has to be maintained at very high temperatures (e.g. 140-175° C.) to maintain sufficient flow characteristics. However, maintaining a polymer modified asphalt at very high temperatures can decay the desired properties of the polymer modified asphalt, thus limiting the storage life.

The polymer-binder composite described herein does not have to be maintained at a high temperature. Thus, the polymer-binder composite described herein does not have a shelf life and is capable of being stored and transported at room temperature. With no apparent shelf life and no heating requirement, the polymer-binder composite described herein can be added to an additional asphalt or bituminous material at any time and at any location to produce polymer modified asphalt. Another benefit of the polymer-binder composite described herein is that the polymer-binder composite is pre-dispersed, whereby it can be added to the additional asphalt or bituminous material to generate the polymer modified asphalt, which can then be immediately emulsified. Polymer-binder composites that disperse in asphalt in less than 3 hours, preferably less than 2 hours, more preferably less than 1 hour, and most preferably less than 15 minutes, which allows for just-in-time production, minimizing the amount of polymer modified asphalt in heated storage, thereby preserving the integrity of the polymer, reducing the amount of thermal cross linking, which hinders emulsification, and reducing costs.

The polymer-binder composite of the present invention can be diluted with additional asphalt or binder material to provide the polymer modified asphalt with varying concentrations of polymer. In one embodiment of the present invention, the polymer modified asphalt can have a concentration of polymer of less than about 3% by weight of the polymer modified asphalt. In another embodiment of the present invention, the polymer modified asphalt can have a concentration of polymer of less than about 9% by weight of the polymer modified asphalt. In a further embodiment of the present invention, the polymer modified asphalt can have a concentration of polymer of less than about 15% by weight of the polymer modified asphalt.

Emulsification processes and materials used with the polymer-binder composite and the polymer-modified asphalt are those traditionally known by those skilled in the art, such as cationic emulsifying agents, anionic emulsifying agents, nonionic emulsifying agents, amphoteric emulsifying agents, zwitterionic emulsifying agents, and combinations thereof. Typical cationic emulsified polymer modified asphalts can be made using known emulsifying agents such as primary amines, diamines, ethoxylated amines, propoxylated amines, imidazolene amines, and the like. Typical anionic emulsified polymer modified asphalts can be made using emulsifying agents known by those skilled in the art, such as salts produced from lignin-based, Vinsol-based, or tall oil-based raw materials. Similarly, nonionic emulsified polymer modified asphalts can be made using known nonionic emulsifying agents such as oxylated nonolphenols. Typical zwitterionic emulsifying agents include, but are not limited to, families like Sulfobetanes and Sultanes of the general formula RN⁺(CH3)₂(CH2)ₓSO₃. It should be understood and appreciated that this is not an exhaustive list of emulsifying agents that can be used. Rather, any emulsifying agent that is known in the art capable of emulsifying the polymer modified asphalt of the present invention can be used.

Satisfactory emulsified embodiments of the present invention include from about 20 percent to about 80 percent by weight polymer modified asphalt with about 80 percent to about 20 percent by weight water, emulsifying agent, and emulsion additives. For special applications, such as thin film resurfacing, a greater or lesser amount of water may be used. Generally, the amount of water used is that amount which will give the emulsified mixture the desired flow characteristics to allow proper placement and curing of the emulsion. Quantity and type of emulsifying agent typically is dictated by the ultimate use of the emulsion. Tests indicate that the quantity and type of emulsifying agents suitable for use with the present invention are consistent with existing asphalt and asphalt-polymer emulsions known in the art.

To produce the emulsified embodiment, the binder, polymer, and/or any additives are first mixed generally as described herein to form a polymer-binder composite. Next, the polymer-binder composite is dispersed in a second asphalt to form a polymer modified asphalt, which is heated to a predetermined temperature that will produce acceptable flow characteristics. Once the polymer modified asphalt is heated to the predetermined temperature, the polymer modified asphalt is introduced into an emulsification mill with the emulsifying agents, emulsion additives, and/or water. Introducing the heated polymer modified asphalt into the emulsification mill allows the final emulsion temperature to be maintained within acceptable limits. Generally, acceptable limits for the final combined temperature of the emulsified polymer modified asphalt are less than about 100° C. so as to prevent flash boiling of the water. It should be understood and appreciated that emulsification temperatures can exceed the boiling point of the aqueous phase with pressure and heat exchange equipment. The mill operates to slice the polymer-binder mix finely and mix it with the water, emulsifier, and emulsion additives to form an emulsion. The emulsifying agent acts to stabilize the resulting emulsion so as to prevent agglomeration of the asphalt prior to placement. The emulsion additives described herein for use in emulsification can be any additive for providing the emulsified polymer modified asphalt with predetermined properties. Examples of additive include, but are not limited to, latex rubber, sulfur containing compounds, thickeners, or other rheology modifiers, tackifiers, flow improvers, pH adjusting chemicals, stabilizers and the like.

### EXAMPLE 1

A polymer-binder composite was produced using a first binder, Trigeant PG67-22 and a polymer, Kraton D1118, which comprises of about 30% bound styrene and a molecular weight of about 100,000 Daltons. The first binder and polymer were combined in a high-shear device, a Leistritz 50 mm extruder with a L/D of 44:1, to produce a polymer-binder composite as described in Table 1.

TABLE 1
Polymer Composite Production

| | |
|---|---|
| D 1118 (Kg/hr) | 172.7 |
| First Binder | Asphalt |
| First Binder Rate (Kg/hr) | 9.1 |
| Polymer in Composite (%) | 95% |
| Process Temp (° C.) | 177-187 |
| Motor Size (Kw) | 224 |
| Motor Efficiency (%) | 97% |
| RPM (max 1200) | 600 |
| Process Torque | 55% |
| Flow Regime | Laminar |
| Sᵣ Max | 3,142 |
| Resonance Time (s) | 12.6 |
| Energy (Kw/Kg) | 0.329 |
| Scalar Shear Quantity | 39,584 |

The resulting composite was converted into spherical particles about 0.25 inches in diameter. The composite was stored for at least 6 months.

A second binder, Suncor PG58-22 was heated in a vessel to about 143° C. The polymer-binder composite was quickly added under very low shear agitation where the shear rate was less than 50 s⁻¹. The asphalt and binder-composite mixture were allowed to agitate for 90 minutes at a temperature of about 143° C. Elemental sulfur was added in a sufficient amount to cross-link the polymer in the asphalt and was allowed to mix for an additional 30 minutes to form the polymer modified asphalt. The total mix time from introduction of the polymer-binder composite to the second asphalt and the commencement of emulsification was exactly 2 hours. The resulting polymer modified asphalt was smooth and homogeneous exhibiting typical polymer modified asphalt properties.

The polymer modified asphalt was emulsified in a Dalworth colloid mill under typical conditions for the emulsification of asphalt using a sufficient amount of MeadeWestvaco Indulin AA-89 cationic emulsifier to achieve 0.28% emulsifier based on the weight of the polymer modified asphalt emulsion, and a sufficient amount of hydrochloric acid to achieve an aqueous solution pH of 2.0 to 2.5. The physical properties of the resulting polymer-modified asphalt emulsion are detailed in Table 2.

TABLE 2
Polymer Modified Asphalt Emulsion Properties

| | | |
|---|---|---|
| Viscosity (SFS at 50° C.) | 250 | AASHTO T 59 |
| Sieve (%) | 0.10 | ASTM D 244 |
| Mean Particle Size (μm) | 3.13 | |
| Residue by Distillation (%) | 71.7 | AASHTO T 59 |

Residuum Property

| | | |
|---|---|---|
| Elastic Recovery @ 25° C., Straight | 50 | AASHTO T 301 |
| Sided Mold, 20 cm, 5 min (%) | | |

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed:

1. An emulsified polymer modified asphalt, comprising:
a polymer-binder composite, comprising:
at least one polymer; and
a first binder,
where the at least one polymer and the first binder are combined in a high shear device to form the polymer-binder composite;
a second binder, where the second binder is mixed with the polymer-binder composite to form a polymer modified asphalt; and
effective amounts of an emulsifying agent and of water to allow emulsification of the polymer modified asphalt.

2. The emulsified polymer modified asphalt of claim 1 wherein the emulsifying agent is cationic.

3. The emulsified polymer modified asphalt of claim 1 wherein the emulsifying agent is anionic.

4. The emulsified polymer modified asphalt of claim 1 wherein the emulsifying agent is nonionic.

5. The emulsified polymer modified asphalt of claim 1 wherein the emulsifying agent is amphoteric.

6. The emulsified polymer modified asphalt of claim 1 wherein the emulsifying agent is zwitterionic.

7. The emulsified polymer modified asphalt of claim 1 further comprising at least one emulsion additive.

8. The emulsified polymer modified asphalt of claim 7 wherein the emulsion additive is selected from the group consisting of latex rubber, sulfur containing compounds, thickeners, or other rheology modifiers, tackifiers, flow improvers, pH adjusting chemicals, stabilizers and the like.

9. The emulsified polymer modified asphalt of claim 1 wherein the polymer-binder composite further comprises at least one additive.

10. The emulsified polymer modified asphalt of claim 1 wherein the at least one polymer has a molecular weight greater than about 60,000 Da.

11. The emulsified polymer modified asphalt of claim 1 wherein the at least one polymer has a molecular weight greater than about 100,000 Da.

12. The emulsified polymer modified asphalt of claim 1 wherein the at least one polymer has a molecular weight greater than about 150,000 Da.

13. The emulsified polymer modified asphalt of claim 1 wherein the at least one polymer has a molecular weight greater than about 200,000 Da.

14. The emulsified polymer modified asphalt of claim 1 wherein the polymer-binder composite mixture is readily soluble when combined with the second binder.

15. The emulsified polymer modified asphalt of claim 1 wherein the at least one polymer and the first binder are subjected to mixing with a resident time in the high shear device of greater than about 0.5 seconds.

16. The emulsified polymer modified asphalt of claim 1 wherein the at least one polymer and the first binder are subjected to mixing with a scalar shear quantity of greater than about 250.

17. The emulsified polymer modified asphalt of claim 1 wherein the at least one polymer and the first binder are subjected to mixing with a scalar shear quantity of greater than about 1000.

18. The emulsified polymer modified asphalt of claim 1 wherein the at least one polymer and the first binder are subjected to mixing with a scalar shear quantity of greater than about 1500.

19. The emulsified polymer modified asphalt of claim 1 where greater than 0.05 kW/kg of energy is utilized to combine the at least one polymer and the first binder.

20. The emulsified polymer modified asphalt of claim 1 where greater than 0.1 kW/kg of energy is utilized to combine the at least one polymer and the first binder.

21. The emulsified polymer modified asphalt of claim 1 where greater than 0.2 kW/kg of energy is utilized to combine the at least one polymer and the first binder.

22. The emulsified polymer modified asphalt of claim 1 wherein the at least one polymer and the first binder are subjected to mixing where the high shear device produces a pressure of greater than 100 psi and maintains laminar flow.

23. The emulsified polymer modified asphalt of claim 1 wherein the at least one polymer and the first binder are subjected to mixing where the high shear device maintains RPMs of less than 1,500 and laminar flow.

24. A method for formulating an emulsified polymer modified asphalt, comprising:
mixing at least one polymer and a first binder in a high shear device to produce a polymer-binder composite;
mixing the polymer-binder composite with a second binder to form a polymer modified asphalt; and
emulsifying the polymer modified asphalt by combining effective amounts of an emulsifying agent and of water with the polymer modified asphalt.

25. The method of claim 24 wherein the high shear device is a high shear extruder.

26. The method of claim 24 wherein the step of mixing the at least one polymer and the first binder in the high shear device to produce the polymer-binder composite further comprises mixing at least one additive into the high shear device along with the at least one polymer and first binder to produce the polymer-binder composite.

27. The method of claim 24 wherein mixing the at least one polymer and the first binder in the high shear device to produce the polymer-binder composite is accomplished in less than one minute.

28. The method of claim 24 wherein the at least one polymer has a molecular weight that is greater than 60,000 Da.

29. The method of claim 24 wherein the at least one polymer has a molecular weight that is greater than 100,000 Da.

30. The method of claim 24 wherein the at least one polymer has a molecular weight that is greater than 150,000 Da.

31. The method of claim 24 wherein the at least one polymer has a molecular weight greater than about 200,000 Da.

32. The method of claim 24 wherein mixing the at least one polymer and the first binder in the high shear device to produce the polymer-binder composite further comprises subjecting the at least one polymer and the first binder to mixing with a resident time in the high shear device of greater than 0.5 seconds.

33. The method of claim 24 wherein mixing the at least one polymer and the first binder in the high shear device to produce the polymer-binder composite further comprises subjecting the at least one polymer and the first binder to mixing with a scalar shear quantity of greater than about 250.

34. The method of claim 24 wherein mixing the at least one polymer and the first binder in the high shear device to produce the polymer-binder composite further comprises subjecting the at least one polymer and the first binder to mixing with a scalar shear quantity of greater than about 1,000.

35. The method of claim 24 wherein mixing the at least one polymer and the first binder in the high shear device to produce the polymer-binder composite further comprises subjecting the at least one polymer and the first binder to mixing with a scalar shear quantity of greater than about 1,500.

36. The method of claim 24 wherein greater than 0.05 kW/kg of energy is utilized to mix the at least one polymer and the first binder in the high shear device to produce the polymer-binder composite.

37. The method of claim 24 wherein greater than 0.1 kW/kg of energy is utilized to mix the at least one polymer and the first binder in the high shear device to produce the polymer-binder composite.

38. The method of claim 24 wherein greater than 0.2 kW/kg of energy is utilized to mix the at least one polymer and the first binder in the high shear device to produce the polymer-binder composite.

39. The method of claim 24 wherein the emulsifying agent is cationic.

40. The method of claim 24 wherein the emulsifying agent is anionic.

41. The method of claim 24 wherein the emulsifying agent is nonionic.

42. The method of claim 24 wherein the emulsifying agent is amphoteric.

43. The method of claim 24 wherein the emulsifying agent is zwitterionic.

44. The method of claim 24 further comprising the step of transporting the polymer-binder composite to a secondary location prior to mixing the polymer-binder composite with the second binder to form the polymer modified asphalt.

45. The method of claim 44 further comprising the step of storing the polymer-binder composite for a predetermined amount of time prior to transporting the polymer-binder composite to the secondary location.

46. The method of claim 24 wherein the step of emulsifying the polymer modified asphalt by combining effective amounts of an emulsifying agent and of water with the polymer modified asphalt further comprises combining an effective amount of an additive with the emulsifying agent and the water.

47. The method of claim 46 wherein the additive is selected from the group consisting of latex rubber, sulfur containing compounds, thickeners, or other rheology modifiers, tackifiers, flow improvers, pH adjusting chemicals, stabilizers and the like.
